(19) United States
(12) Patent Application Publication
(10) Pub. No.: US 2018/0085265 A1
(43) Pub. Date: Mar. 29, 2018

(54) Invalid lift device

(71) Applicants: Tim Arndorfer, Frisco, TX (US); Felix Saenz, Frisco, TX (US)

(72) Inventors: Tim Arndorfer, Frisco, TX (US); Felix Saenz, Frisco, TX (US)

(21) Appl. No.: 15/712,430

(22) Filed: Sep. 22, 2017

Related U.S. Application Data
(60) Provisional application No. 62/398,571, filed on Sep. 23, 2016.

(51) Int. Cl. A61G 3/06; A61G 5/10

(52) U.S. Cl. CPC A61G 3/06; A61G 5/104

(57) ABSTRACT

An invalid lift device for lifting a wheelchair and an invalid may include a seat support to connect to a seat; a pivoting swing arm to pivot the seat support; and a guide track to move the seat support longitudinally.

### FIELD OF THE INVENTION

This invention relates to an apparatus for transferring wheelchair invalids into and out of a motor vehicle seat.

### BACKGROUND

Paraplegics and others who have lost the use of their legs and are therefore confined to wheelchairs have a difficult time getting into and out of automobiles. Automobile seats are traditionally low to the ground, resulting in the need to raise or lower the individual invalid from the automobile seat, and automobile doors traditionally open only a limited arc and may be an obstacle for an individual who needs additional room. Prior invalid car lift devices are known and examples are disclosed in U.S. Pat. Nos. 2,650,725, 3,656,637, 3,677,424 and 3,983,584.

The invalid car lift of U.S. Pat. No. 3,656,637 includes an extendible bar having a winch mechanism attached thereto. The extendible bar is configured for mounting onto the side rain gutter of an automobile. It will be appreciated that such mounting entails certain difficulties in view of the fact that many rain gutters cannot support the weight of the lifting device and invalid being carried thereby. In addition, many modern vehicles no longer include rain gutters thereon.

### SUMMARY

The invalid lift device of the present invention provides at least two dimensions of mobility for an invalid. In one embodiment, the dimensions of mobility may be at a substantially right angle. One dimension may be substantially vertically and another dimension may be substantially longitudinal. The invalid lift device may include a seat for the invalid and a seat support such as a vertical lift assembly for the seat and to support the seat and the seat support, and seat support may pivot substantially in the horizontal plane in order to move the invalid towards and away from the vehicle. Additionally, the seat and seat support may move longitudinally along the guide track in order to move the invalid towards and away from the vehicle. The seat and seat support may be connected to a bearing carrier assembly which may travel along the guide track which may be linear or curved. The guide track may be connected to the vehicle by a vehicle mounting arm. The vehicle mounting arm may be substantially horizontal or vertical to connect to the vehicle. Optionally, a user stabilization support may connect to the seat support and the seat in order to stabilize the invalid.

The invalid lift device may include a drive actuator which may be a rotary actuator, motor and may be electric or hydraulic to drive the vertical lift assembly and seat to pivot and to move along the guide track.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the invalid lift device of the present invention.

### DETAILED DESCRIPTION

The invalid lift device 100 provides vertical and horizontal access for the invalid and may be designed for two door or four-door vehicles (or more doors). The invalid lift device 100 provides driver or passenger side access and provides the ability for a wheelchair to be stored in the backseat of the vehicle, and eliminating the need for a crane. The present invention eliminates the need for structural modifications to the vehicle and provides access to two or more doors on the same side of the vehicle. The present invention provides multiple user control positions and adapts to any vehicle with sufficient ground clearance. More particularly, the invalid lift device 100 adapts to relatively tall vehicles, four by fours, trucks, SUVs, commercial vehicles, RVs and the like. The present invention may be stored under the vehicle and may be driven by mechanical, electrical, and hydraulic mechanisms.

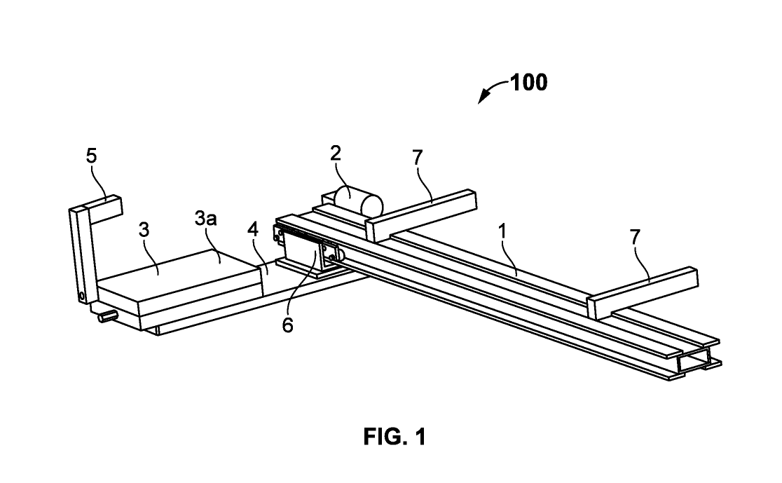

The invalid lift device 100 as illustrated in FIG. 1 of the present invention provides at least two dimensions of mobility for an invalid. In one embodiment, the dimensions of mobility may be at a substantially right angle. One dimension may be substantially vertically and another dimension may be substantially longitudinal. The invalid lift device 100 may include a seat 3a for the invalid and a seat support 3 such as a vertical lift assembly 3 for the seat 3a and to support the seat 3a, and the seat 3a, and seat support 3 may pivot substantially in the horizontal plane by virtue of a pivoting swing arm 4 in order to move the invalid towards and away from the vehicle (not shown). Additionally, the seat 3a and seat support 3 may move longitudinally along the guide track 1 which may include a linear bearing rail in order to move the invalid towards, along and away from the vehicle. The seat 3a and seat support 3 may be connected to a bearing carrier assembly 6 which may travel along the guide track 1 which may be linear or curved. The guide track 1 may be connected to the vehicle by a vehicle mounting arm 7. The vehicle mounting arm 7 may be substantially horizontal or vertical to connect to the vehicle. Optionally, a user stabilization support 5 may connect to the seat support and the seat in order to stabilize the invalid.

The invalid lift device 100 may include a drive actuator 2 which may be a rotary actuator, motor and may be electric or hydraulic to drive the vertical lift assembly 3 and seat 3a to pivot and to move along the guide track 1.

In operation, the seat 3a may be positioned adjacent to the seat of the vehicle. The invalid moves from the seat of the vehicle to the seat 3a. The drive actuator 2 pivots the pivoting swing arm 4 along with the seat support 3 from an extended position adjacent to the vehicle seat to a traveling position adjacent to the guide track 1. The drive actuator numerous 2 engages the bearing carrier assembly 6 to move the seat 3a and the seat support 3 along the guide track 1 to a position where the invalid can safely be transferred to a wheelchair or other device.

In order for the invalid to be placed in the vehicle seat, the above operation may be substantially reversed.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An invalid lift device for lifting a wheelchair and an invalid, comprising:
a seat support to connect to a seat;
a pivoting swing arm to pivot the seat support;
a guide track to move the seat support longitudinally.

2) An invalid lift device for lifting a wheelchair and an invalid as in claim 1, wherein the seat support supports a chair.

3) An invalid lift device for lifting a wheelchair and an invalid as in claim 1, wherein the guide track is a linear bearing rail.

4) An invalid lift device for lifting a wheelchair and an invalid as in claim 1, wherein the seat support is connected to a stabilization support to stabilize the seat.

5) An invalid lift device for lifting a wheelchair and an invalid as in claim 1, wherein the lift device includes a drive actuator to drive the vertical lift assembly.

6) An invalid lift device for lifting a wheelchair and an invalid as in claim 1 wherein the seat support is a vertical lift assembly.

7) An invalid lift device for lifting a wheelchair and an invalid as in claim 1, wherein the seat support is connected to a bearing carrying assembly.

8) An invalid lift device for lifting a wheelchair and an invalid An invalid lift device for lifting a wheelchair and an invalid as in claim 1, wherein the guide track 1 may be connected to a vehicle by a vehicle mounting arm.
